(19) United States
(12) Patent Application Publication
(10) Pub. No.: US 2026/0241354 A1
(43) Pub. Date: Aug. 20, 2026

(54) KITCHEN APPLIANCE BASE FOR A KITCHEN APPLIANCE AND PREPARATION MODULE

(71) Applicant: Vorwerk & Co. Interholding GmbH, Wuppertal (DE)

(72) Inventor: Christian Bayard, Witten (DE)

(21) Appl. No.: 19/190,917

(22) Filed: Apr. 28, 2025

(30) Foreign Application Priority Data
May 2, 2024 (EP) 24173957.2

(51) Int. Cl. B01F 35/31; A47J 43/046; A47J 43/08; B01F 27/808; B01F 35/32; B01F 35/45; B01F 101/00

(52) U.S. Cl. CPC B01F 35/31; A47J 43/046; A47J 43/085; B01F 27/808; B01F 35/3212; B01F 35/3213; B01F 35/45; B01F 2101/1805

(57) ABSTRACT

A kitchen appliance base for a kitchen appliance, with at least one receiving area for at least one preparation module, wherein the receiving area has at least one actuating unit for mechanical interaction with the preparation module, wherein the actuating unit has at least one drive unit, at least one actuating element rotatably held about a rotation axis R, and at least one stationary holding element, wherein the actuating element has at least one driver element, wherein the actuating element is rotatable at least indirectly by means of the drive unit at least between a first position and a second position. The holding element and the driver element overlap at least partially in the first position in a direction parallel to the rotation axis R1 of the actuating element.

### CROSS REFERENCE TO RELATED APPLICATIONS

This application claims the benefit of priority under 35 U.S.C. § 119 to European Patent Application No.: 24173957.2, filed May 2, 2024, the contents of which is incorporated herein by reference in its entirety.

### FIELD

The invention relates to a kitchen appliance base for a kitchen appliance, with at least one receiving area for at least one preparation module. Furthermore, the invention relates to a preparation module for such a kitchen appliance base.

### BACKGROUND

The statements in this section merely provide background information related to the present disclosure and several definitions for terms used in the present disclosure and may not constitute prior art.

Kitchen appliance with kitchen appliance base and preparation module, for example comprising a preparation vessel and at least one lid, are known in a variety of configurations. Such kitchen appliances serve for automatic, semi-automatic or manual preparation, e.g. chopping, grinding, pressing, stirring, cooking, steam cooking and/or keeping warm, particularly of food. The kitchen appliance usually has a kitchen appliance base that provides at least one receiving area for at least one preparation module, e.g. with a preparation vessel. The receiving area often has at least one electrical interface to supply a preparation module arranged in the receiving area with at least one working voltage, for example for a heating device of the preparation module, or to contact sensors, for example.

Alternatively or additionally, at least one mechanical interface, e.g. a tool interface, is provided in the receiving area, which serves, for example, to transmit torque from a working unit, e.g. a motor, of the kitchen appliance base to a tool arranged on the preparation module, for example.

It is known that a preparation module is introduced into the receiving area of a kitchen appliance base and is form-fittingly locked there with the kitchen appliance base by a movement, for example a rotation, effected by an actuating unit of the kitchen appliance base. Furthermore, it is known that simultaneously with the locking of the preparation vessel with the kitchen appliance base, a locking of a lid with the preparation module is effected. For example, EP 3 875 003 A1 discloses a preparation vessel that can be locked by interaction of a gear wheel and a worm wheel.

Although conventional kitchen appliance bases already meet very high requirements for reliable function in locking the preparation vessel and in actuating mechanical functions of the preparation module by the kitchen appliance base, there is still a need to increase the reliability of the interaction between kitchen appliance base and preparation module and to reduce the occurrence of malfunctions, for example due to mechanical blockage during use by a user. Furthermore, user comfort should be increased.

Based on conventional art, the present disclosure is based on the objective of providing a kitchen appliance base and a preparation module that ensure reliable mechanical interaction.

### SUMMARY

The aforementioned objective is solved in a generic kitchen appliance base having at least one receiving area for at least one preparation module, wherein the receiving area has at least one actuating unit for mechanical interaction with the preparation module, wherein the actuating unit has at least one drive unit, at least one actuating element rotatably held about a rotation axis, and at least one stationary holding element, wherein the actuating element has at least one driver element, and wherein the actuating element is rotatable at least indirectly by means of the drive unit at least between a first position and a second position. In this kitchen appliance base the holding element and the driver element at least partially overlap in the first position in a direction parallel to the rotation axis of the actuating element.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows an embodiment of a kitchen appliance with preparation module in perspective view;

FIG. 2a to 2c show an embodiment of a lid in different states on a preparation vessel;

FIG. 3a to 3d show a schematic representation of the function of a blocking means;

FIG. 4 shows a preparation vessel according to FIG. 1 in perspective view;

FIG. 5 shows the preparation vessel according to FIG. 4 in partial exploded view;

FIG. 6 shows a part of a preparation vessel according to FIG. 4 in perspective view;

FIG. 7 shows an embodiment of a housing for a preparation vessel;

FIG. 7a shows a detail view of the housing according to FIG. 7;

FIG. 8 shows an embodiment of a locking unit in perspective view;

FIG. 9 shows the embodiment of a preparation module according to FIG. 1 without housing;

FIGS. 10a and 10b show an embodiment of a counter-element with transmission element and lid locking element;

FIG. 11 shows an embodiment of a preparation module in perspective view from below;

FIG. 12a to 12c show an exemplary sequence of locking a tool holder in a preparation vessel;

FIG. 13 shows an embodiment of a lid from the lid underside;

FIG. 14 shows an embodiment of a support unit on a preparation module;

FIG. 15 shows a sectional view in the area of the lid of a preparation module;

FIG. 16 shows a receiving area of a kitchen appliance base in perspective view in a first state;

FIG. 17 shows the receiving area according to FIG. 16 in a second state;

FIG. 18 shows a section through the receiving area with attached preparation vessel;

FIG. 19 shows a detail view of an embodiment of a housing from the underside;

FIG. 20 shows an embodiment of a housing in perspective view; and

FIG. 21 shows an embodiment of a kitchen appliance base in partial section.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

In general, the present disclosure relates to a kitchen appliance base for a kitchen appliance, with at least one receiving area for at least one preparation module. The receiving area has at least one actuating unit for mechanical interaction with the preparation module. The actuating unit has at least one drive unit, at least one actuating element rotatably held about a rotation axis, and at least one stationary holding element. The actuating element has at least one driver element. The actuating element is rotatable at least indirectly by means of the drive unit at least between a first position and a second position. Furthermore, the invention relates to a preparation module for such a kitchen appliance base.

The kitchen appliance base for a kitchen appliance has at least one receiving area for at least one preparation module. For example, the receiving area is designed such that the preparation module can be received at least partially form-fittingly and/or that the preparation module receives at least part of the receiving area and/or the preparation module can be placed on a substantially flat surface in the receiving area. In the receiving area of the kitchen appliance base, at least one actuating unit is arranged that serves for mechanical interaction with the preparation module.

In particular, the preparation module is designed such that it can at least partially receive the actuating unit. For example, it is provided that the at least one counter-element of the preparation module is movable, in particular rotatable, by a movement of the actuating unit when the preparation module is arranged in the receiving area. Preferably, a rotation speed of the actuating unit, in particular of the actuating element, of the kitchen appliance base and of the counter-element of the preparation module is the same during rotation. Preferably, it is provided that with a movement of the actuating unit, in particular via the counter-element, a locking of the preparation module in the receiving area with the kitchen appliance base can be effected and/or that a lid can be locked with the preparation module by a movement of the actuating unit. The preparation module has, for example, at least one preparation vessel with preparation interior space or at least one heating module with placement surface for a cooking pot or at least one warming area.

The receiving area of the kitchen appliance base has at least one electrical counter-interface, in particular to supply a preparation module that can be arranged in the receiving area with at least one working voltage, for example for a heating device of the preparation module, or for example to contact sensors.

Alternatively or additionally, at least one mechanical interface, e.g. a tool interface, is provided in the receiving area, which serves, for example, to transmit torque from a working unit, e.g. a motor, of the kitchen appliance base to a tool or a tool holder arranged on the preparation module, for example.

The preparation module serves—when used with the kitchen appliance base—for automatic, semi-automatic or manual preparation, e.g. chopping, grinding, pressing, stirring, cooking, steam cooking and/or keeping warm, particularly of food. The preparation vessel has in particular at least one electrical heating means for heating the preparation chamber. Furthermore, the preparation vessel has at least one electrical interface, for example for contacting the heating means and/or for contacting sensors. The electrical interface is designed in particular for interaction with the electrical counter-interface of the kitchen appliance base.

The actuating unit of the kitchen appliance base has at least one drive unit at least for moving an actuating element of the actuating unit. The drive unit or the components of the drive unit are preferably arranged at least partially below a top side of the kitchen appliance base, in particular below a cover. In particular, the actuating element extends under the cover to interact with the drive unit. The actuating unit has at least the actuating element rotatably held about a rotation axis and at least one stationary holding element. The stationary holding element is stationary relative to a top side of the kitchen appliance base, while the rotatably held actuating element is movable relative to the top side of the kitchen appliance base or the receiving area. The actuating element is rotatable at least indirectly by means of the drive unit at least between a first position and a second position. For example, the first position is a release position in which the preparation module can be introduced into the receiving area and removed from it, and the second position is a locking position in which the preparation module is locked with the kitchen appliance base, in particular in the receiving area. Preferably, additional positions are provided in addition to the first position and the second position, which are linked to additional functions, for example via a lid locking unit respectively a lid locking element. For example, the lid is locked with the preparation vessel in the second position.

According to one aspect of the present disclosure, it is provided that the holding element and the driver element at least partially overlap in the first position, for example in a release position, in a direction parallel to the rotation axis of the actuating element. In particular, the holding element and the driver element overlap approximately over half of their cross-sectional area in this direction. The rotation axis is in particular oriented perpendicular to a top side of the kitchen appliance base. Through this arrangement in the first position, a preparation module can be introduced in a simple manner onto the kitchen appliance base and in particular into its receiving area. The electrical counter-interface is arranged within the actuating unit.

Preferably, it is provided that the holding element and the driver element completely overlap in the first position in a direction parallel to the rotation axis of the actuating element. It is provided that the holding element and the driver element have an approximately matching cross-sectional area in this direction, so that they are advantageously arranged congruently in the first position. For example, it is also provided that the cross-sectional area of the driver element is larger than the cross-sectional area of the holding element. This embodiment has the advantage that the holding element and the driver element form a more compact unit that can interact with the underside of a preparation module with less space requirement.

In particular, it is provided that the actuating element has at least or exactly three, at least or exactly four, or at least or exactly five driver elements. The driver elements are preferably distributed uniformly over the circumference. Preferably, the actuating unit has a number of stationary holding elements corresponding to the driver elements. Preferably, all holding elements and all driver elements each have at least partial, in particular complete, overlap in the first position. Only when the driver element moves with the actuating element from the first position to the second position does the driver element rotate out of the overlap with the respective holding element.

For example, the driver element is arranged above the holding element in an application direction of a preparation vessel or in a direction parallel to the rotation axis. In particular, the holding element has a smaller distance to a top side of the kitchen appliance base than the driver element. By moving the driver element or the driver elements from the first position to the second position or from the second position to the first position, a mechanical function within the preparation module can be actuated when the preparation module is introduced into the receiving area, for example opening or closing a valve and/or locking and unlocking a lid and/or locking the preparation vessel in the receiving area.

The kitchen appliance base advantageously has a weighing function, so that food arranged in or on a preparation module can be weighed. It is particularly provided that weighing sensors are arranged on the feet of the kitchen appliance base and/or that weighing sensors are arranged in the receiving area.

The present disclosure provides the advantage over conventional art that such an arrangement of moving and stationary elements significantly reduces the risk of malfunction in the interaction between the actuating unit and the preparation module and thereby increases user comfort. In addition, a combination of a movable driver element and a stationary holding element on the kitchen appliance base enables a mechanical function in the preparation module to be effected with the driver element without necessarily locking the preparation module with the kitchen appliance base. It is also conceivable that the preparation module is only placed in the receiving area.

According to a first embodiment of the kitchen appliance base, it has proven particularly advantageous if it is provided that the driver element has no overlap with the holding element in a direction parallel to the rotation axis in the second position, in particular a locking position, of the actuating element. The driver element is consequently completely rotated out of the overlap with the holding element. The driver element preferably interacts form-fittingly with a counter-element of the preparation module during movement, in particular by the driver element moving the counter-element. Preferably, it is provided that the driver element moves through an angle of approximately between 10° and 40° between the first position and the second position. It is particularly preferably provided that the driver element rotates through an angle of approximately 32° starting from the first position and is then reset by approximately 2° in the opposite direction. The resetting serves to relieve stresses in the mechanical components, in particular of the preparation module.

A further embodiment of the kitchen appliance base provides that the holding element or the holding elements extend substantially radially away from the rotation axis of the actuating element. At least part of the holding element consequently extends approximately orthogonally to the rotation axis of the actuating element. Preferably, the holding element or each holding element has at least one holding surface oriented in a direction towards of a top side of the kitchen appliance base. The holding surface preferably interacts with the preparation module, in particular an active section of the counter-element, in the second position of the actuating element respectively the driver elements.

In order to advantageously pull the preparation module slightly in the direction of a surface of the receiving area when the preparation module is to be locked with the receiving area by means of the holding surface, at least part of the holding surface is formed with a convex curvature. The convex curvature extends in the direction of the surface of the receiving area. Preferably, the holding surface is completely convexly curved. This produces the highest holding force on a preparation module when the preparation module, in particular an active section of a counter-element, interacts with the area of the holding surface at the apex of the convex curvature.

To simplify the introduction of a preparation module into the receiving area, according to a further embodiment of the kitchen appliance base, it is provided that the receiving area has at least one insertion element, and that the insertion element and the holding element at least partially or completely overlap in a direction parallel to the rotation axis of the actuating element. The insertion element consequently serves, among other things, to guide the preparation module at least partially over the holding element and the driver element when it is introduced into the receiving area. Preferably, a number of insertion elements is provided that corresponds to the number of holding elements respectively to the number of driver elements. Furthermore, the insertion element respectively the insertion elements can serve to receive a plate or a bowl to weigh their contents.

The insertion element is preferably arranged such that the driver element is at least partially or completely arranged between the insertion element and the holding element in the first position. The insertion element, the driver element and the holding element preferably have a matching cross-sectional area in this direction. The insertion element and in particular also the holding element serve to guide the preparation module into the correct position in the receiving area during introduction into the receiving area. Subsequently, a relative movement of the driver element respectively the driver elements to the preparation module and thus a mechanical interaction with the preparation module, in particular a counter-element, can take place.

The insertion element also has the particular advantage that it prevents rotation of the preparation vessel, in particular the housing, when a counter-element of the preparation vessel is moved by an actuating element of the kitchen appliance base, by the preparation vessel being supported on the insertion element. This allows mechanical functions in the preparation module to be effected with the actuating element without the preparation module having to be locked with the kitchen appliance base.

A further embodiment of the kitchen appliance base provides that at least one contact cover for at least partially covering an electrical counter-interface is arranged in the receiving area. In particular, the contact cover is part of the actuating unit. Preferably, the contact cover forms the top side of the actuating unit. The electrical counter-interface is arranged in the receiving area of the kitchen appliance base and serves for interaction with an electrical interface on the preparation module. The electrical contacts of the counter-interface are at least partially covered by the contact cover. In particular, the contact cover has at least one contact protection that directly covers the electrical contacts of the electrical interface. The contact protection serves in particular to protect the contacts from liquids and is preferably made of a soft material, e.g. silicone. The contact protection preferably has a number of penetrations corresponding to the number of contacts, in particular six, which expand elastically under the action of a contact pin of the counter-interface.

It is advantageously provided that the insertion element is part of the contact cover. Preferably, the insertion element is formed integrally with the contact cover. If a plurality of insertion elements is provided, these are all part of the contact cover. In particular, it is provided that the actuating element is arranged below the contact cover. The actuating element and the contact cover preferably have the same diameter. In particular, the holding elements are also arranged below the contact cover, preferably below the actuating element, in particular the driver elements.

According to a further embodiment of the kitchen appliance base, it is particularly preferably provided that the top side of the kitchen appliance base, in particular the receiving area, is substantially flat, so that a preparation module can be placed on the top side in the receiving area. It is provided that the actuating unit protrudes from the top side in the receiving area, so that the actuating unit, in particular with the contact cover and the insertion elements, can penetrate into a preparation module from the underside. The preparation module has in particular a corresponding recess to be able to at least partially receive the actuating unit with the contact cover. Preferably, the actuating unit with the contact cover is substantially circular.

The receiving area is preferably designed such that form-fitting interaction with the preparation module takes place via the actuating unit and the contact cover. In a surrounding area of the actuating unit, the preparation module merely rests on a substantially flat top side of the kitchen appliance base.

A further embodiment of the kitchen appliance base provides that the actuating element is designed as an actuating ring, in particular that the driver element is designed as a radially protruding web. Preferably, a thickness of the web substantially corresponds to a thickness of the actuating ring. The width of the web preferably corresponds approximately to the width of the insertion element respectively the holding element. The web is in particular oriented substantially parallel to a top side of the kitchen appliance base. For example, the web has a surface pointing toward the top side of the kitchen appliance base and a surface pointing away from this surface. Both surfaces are preferably oriented substantially parallel to the top side of the kitchen appliance base. Furthermore, the web has two lateral actuating surfaces that are designed for interaction with the preparation module, in particular a driver counter-surface and a reset surface of the driver counter-element on the counter-element.

In particular to be able to move the actuating element, according to a further embodiment, it is provided that the drive unit has at least one motor and at least one gear wheel. The gear wheel is operatively connected to the actuating element to rotate the actuating element. For example, the actuating element has internal teeth into which the gear wheel engages. The motor is directly or indirectly connected to the gear wheel, for example via a worm wheel. It is also provided that the motor is connected to the gear wheel or the actuating element via a toothed disk. The motor, the gear wheel and the actuating element are in particular operatively connected such that the actuating element can be rotated with the motor between the first position and the second position.

The present disclosure further relates to a preparation module for arrangement in a receiving area of a kitchen appliance base, in particular according to one of the described embodiments. The preparation module has at least one counter-element rotatably mounted about a rotation axis, which is rotatable at least between a first position and a second position. The preparation module can be arranged in a receiving area of a kitchen appliance base, for example by being placed on the receiving area. The preparation module has, for example, at least one heating surface for a cooking pot or has a preparation vessel and in particular also a lid.

Furthermore, the preparation vessel preferably has at least one mechanical interface, for example for transmitting torque for a tool, which is designed for interaction with a mechanical counter-interface of the kitchen appliance base, in particular a tool interface. The preparation vessel preferably has at least one rotatable tool that is firmly connected to the preparation vessel or is detachably held in the preparation vessel, in particular on a tool holder. In particular, the tool is coupled to the mechanical interface.

The preparation chamber of the preparation vessel can be closed with the lid, for example, wherein the lid can be locked using a lid locking element. A seal is advantageously arranged between the lid and the preparation vessel. Preferably, the seal is designed to center the lid when placing it on. For example, the seal is held on the lid by a welded retaining ring.

The preparation vessel preferably has at least one handle for transport and for easier handling. The handle is in particular oriented substantially vertically and is arranged on an outside of the housing of the preparation vessel.

The counter-element of the preparation module has at least one active section protruding in the direction of the rotation axis and at least one driver counter-element. The driver counter-element has at least one driver counter-surface for interaction with a driver element of the kitchen appliance base described above. The driver counter-surface is arranged offset along a direction parallel to the rotation axis of the counter-element from the active section. In this way, advantageous interaction with a holding element of a kitchen appliance base can take place.

The counter-element has at least one recess into which the driver element can penetrate when introducing the preparation module into the receiving area, in particular along a direction parallel to the rotation axis. The recess is preferably arranged adjacent to the driver counter-element. The number of recesses preferably corresponds to the number of driver elements of the kitchen appliance base. Likewise, the number of active sections corresponds to the number of holding elements of the kitchen appliance base to enable advantageous interaction of the kitchen appliance base with the preparation module.

For example, a rotation of the driver element-through a force applied to the driver counter-surface-causes a movement of the driver counter-element. This rotates the active section under the holding element so that it interacts form-fittingly with the holding surface of the holding element to be able to transmit a force in a direction parallel to the rotation axis. This locks the preparation module with the receiving area of the kitchen appliance base and the preparation module can no longer be removed until the counter-element has been rotated back to the first position by means of a reset surface.

According to one embodiment, the preparation module has at least one preparation vessel and at least one lid. It is preferably provided that the preparation module has at least one lid, in particular for at least partially or completely closing the preparation chamber. However, it is also provided that the lid locking element can be used for locking special lids that do not serve or do not only serve to close the preparation vessel. The preparation module preferably has at least one functional module. The functional module can be placed on a lid and/or the preparation vessel, for example, and/or can be introduced partially or completely into the preparation vessel, in particular into a preparation chamber. The functional module is designed, for example, as attachment accessory or as insert accessory. It is particularly preferably provided that the lid is designed as a functional module. This is equivalent to the functional module having a lid interface.

Furthermore, it is advantageously provided that the functional module has at least one connection interface for interaction with a tool and/or a tool holder of the preparation vessel to use, for example, a rotation of the tool. This is particularly useful for a functional module that has a tool function—an accessory tool—for example a juicer module, a cutting module or a peeling module.

The functional module particularly preferably has at least one lid interface to interact with a lid locking unit of the preparation vessel, in particular a lid locking element, and to lock and unlock the functional module—like a lid—with the accessory vessel. The functional module is reliably held on the preparation vessel or in the preparation vessel during use through the interaction. The functional module represents in this sense in particular a special lid. The lid interface preferably has part or all of the features of the described features of a lid that it needs for interaction with the lid locking unit, in particular the lid locking element. In particular, for example, at least one or a plurality of cams and/or centering elements and/or a support unit.

The functional module is, for example, a cleaning module, a stirring module, a juicer module, a steam cooking module, a warming module, a peeling module, a cutting module or a grating module. Each of the aforementioned functional modules is designed, for example, as an insert or as an attachment, e.g. a cleaning insert or a cleaning attachment. Such functional modules that do not have a lid interface and can be completely introduced into the preparation chamber can be used in particular with a normal lid.

The preparation vessel has at least one preparation chamber for receiving food, which can be closed with the lid. Furthermore, at least one lid locking element is included with which the lid can be locked. The counter-element has at least one transmission element rotatable with the counter-element about the rotation axis. The transmission element is operatively connected to the lid locking element, so that the lid locking element can be moved, in particular rotated, at least between a lid release position and a lid locking position by rotation of the transmission element—effected by the counter-element. For example, the counter-element, the lid locking element and the transmission element rotate about a common rotation axis.

According to a further embodiment, it is advantageously provided that a rotation of the counter-element and a movement of the lid locking element, in particular a rotation of the lid locking element relative to the preparation chamber and relative to the lid of the preparation vessel, takes place. The lid does not rotate and remains in its position. During locking or unlocking, only a translational movement parallel to the rotation axis takes place. Preferably, rotation of the lid is prevented by a, in particular form-fitting, interaction of a support element on the preparation vessel and a support counter-element on the lid.

According to a further embodiment of the preparation module, it is provided that the lid locking element has at least one locking cam track for locking the lid. The lid has at least one cam for this purpose. The locking cam track represents a contour in which the cam is guided during movement of the lid locking element to lock or unlock the lid when it is moved, in particular rotated, relative to the cam. For example, the locking cam track has at least one run-up slope that, in interaction with the cam, causes the lid to be drawn toward the preparation vessel by the cam sliding on the run-up slope.

The run-up slope is preferably designed such that it causes at least an axial displacement of the cam in a direction parallel to a longitudinal axis of the preparation vessel during rotation of the lid locking element. This brings the lid closer to the preparation vessel by the distance along the longitudinal axis by which the cam is also moved by the run-up slope.

It is advantageously provided that the lid locking element has at least or exactly two, at least or exactly three, or at least or exactly four locking cam tracks and the lid has at least or exactly two, at least or exactly three, or at least or exactly four cams, in particular wherein one cam interacts with one locking cam track in each case. For example, it is provided that the locking cam track has at least one locking surface. The cam rests against the locking surface in the lid locking position of the lid and is prevented by it from moving in a direction parallel to the longitudinal axis of the preparation vessel, whereby the lid is locked on the preparation vessel.

So that the cams can interact with the lid locking unit or the lid locking element, the inner pot has a number of recesses in an upper edge corresponding to the number of cams. Particularly preferably, at least or exactly four recesses are provided. The recesses are preferably arranged in pairs, wherein an angle of approximately 60° is formed between the recesses of a pair-starting from the longitudinal axis L. An angle of approximately 120° is formed between the recesses of the two pairs.

According to a further embodiment of the preparation module, it has proven particularly advantageous if it is provided that the locking cam track has at least one blocking position, and that the cam is forced into the blocking position, in particular into a recess, as a blocking element of a blocking means during movement toward the lid release position if a force acts on the lid or starting from the preparation chamber in a direction parallel to a longitudinal axis of the preparation vessel during the movement. This blocks further rotation of the lid locking element into the release position. Only when the force no longer acts can the cam be moved to the lid release position.

Preferably, the cam is arranged on the lid and the locking cam track is arranged on the lid locking element rotatable about the rotation axis. The cam is consequently guided by the locking cam track to lock the lid with the preparation vessel, but is also used to block complete unlocking of the lid when a described force acts on the lid. Preferably, the cam rests against the first and second blocking surfaces in a recess in the blocking position. The recess is formed, for example, between the locking surface and the run-up slope on the locking cam track. This recess represents, for example, a setback directly between the end of the run-up slope and the locking surface.

According to a further embodiment, it is preferably provided that the inner pot has at least one rib, in particular on a foot area. The rib protrudes from the foot area in the radial direction, for example. The rib is preferably oriented orthogonally to a rotation axis of a tool for the inner pot, or the rib preferably lies in a plane to which the rotation axis is a plane normal. Preferably, the housing, in particular a locking unit, has at least one counter-rib. The counter-rib is arranged in the locking position of the locking unit such that it collides with the rib on the inner pot when an attempt is made to insert the inner pot into the housing. This prevents the inner pot from being insertable into the housing when the housing is arranged on a kitchen appliance base, in particular preventing the inner pot from being inserted subsequently. When the housing—alone—is arranged on the kitchen appliance base, interaction with the actuating unit prevents unlocking of the locking unit from occurring. In the unlocking position of the locking unit, the inner pot can be inserted into the housing.

The present disclosure further relates to a method for operating a kitchen appliance base, in particular according to one of the described embodiments, with a preparation module, in particular according to one of the described embodiments. The method has at least the following method steps:
Arranging the preparation module in a receiving area of the kitchen appliance base; and
Effecting a rotation of an actuating unit of the kitchen appliance base with a drive unit of the kitchen appliance base, wherein the actuating unit, in particular at least one driver element, interacts form-fittingly with a counter-element of the preparation module to rotate the counter-element at least relative to a housing, and wherein at least the housing is supported on at least one stationary insertion element of the actuating unit to prevent rotation of the preparation module on the kitchen appliance base during rotation of the counter-element.

One embodiment of the method provides that the counter-element has at least one active section that can be rotated under a stationary holding element of the kitchen appliance base by the rotation, in particular in a first direction, to lock the preparation module with the kitchen appliance base and can be rotated away from the holding element by an opposite rotation, in particular in a second direction opposite to the first direction, to unlock the preparation module from the kitchen appliance base. For this purpose, the active section must in particular be rotated so far away that there is no longer any overlap with the holding element in a direction parallel to a rotation axis respectively a longitudinal axis of the preparation vessel.

Further embodiments of the functional and structural features of the method result from the description of the embodiments of the preparation vessel, the kitchen appliance base or the kitchen appliance and their function.

Furthermore, the present disclosure relates to a use of a preparation module, in particular according to one of the described embodiments, on a kitchen appliance base of a kitchen appliance according to one of the described embodiments.

Finally, the present disclosure also relates to a kitchen appliance with a kitchen appliance base and a preparation module according to one of the described embodiments.

Further advantageous embodiments of the present disclosure result from the following description of figures. In the various figures in the drawing, identical parts are always provided with the same reference numerals.

For the following description, it is claimed that the present disclosure is not limited to the embodiments and thereby not to all or several features of described feature combinations, rather each individual partial feature of the/each embodiment is also significant for the subject matter of the present disclosure detached from all other partial features described in connection therewith and also in combination with any features of another embodiment.

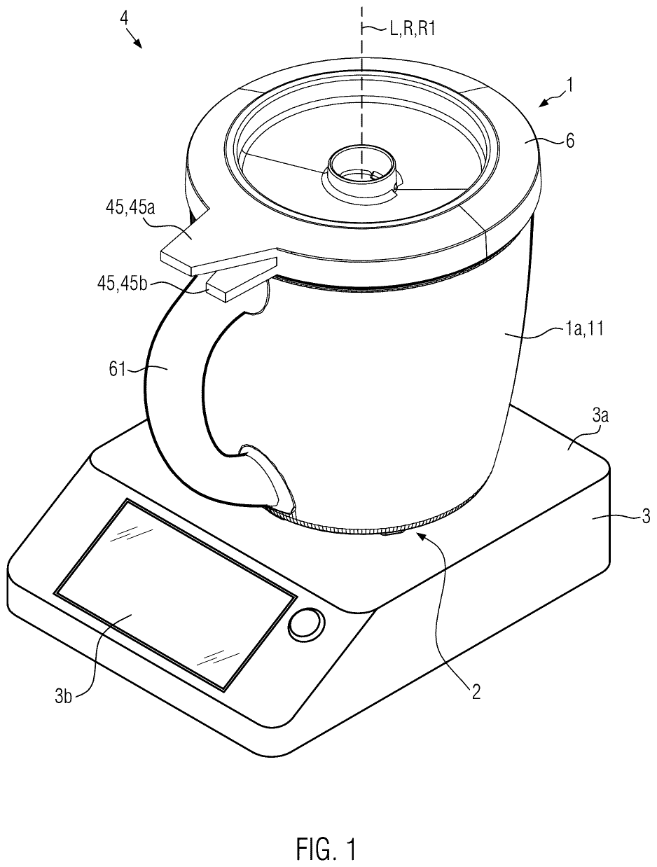

FIG. 1 shows an embodiment of a preparation module 1 that is intended for arrangement in a receiving area 2 of a kitchen appliance base 3 of a kitchen appliance 4. The preparation module 1 here comprises a preparation vessel 1a and a lid 6. The preparation vessel 1 can be placed on a flat top surface 3a of the kitchen appliance base 3 to cooperate with the kitchen appliance base 3. The kitchen appliance base 3 has at least one combined display and input device 3b in the form of a touchscreen to control functions of the kitchen appliance 4. Additionally, a further electromechanical input device in the form of a rotary switch may be present.

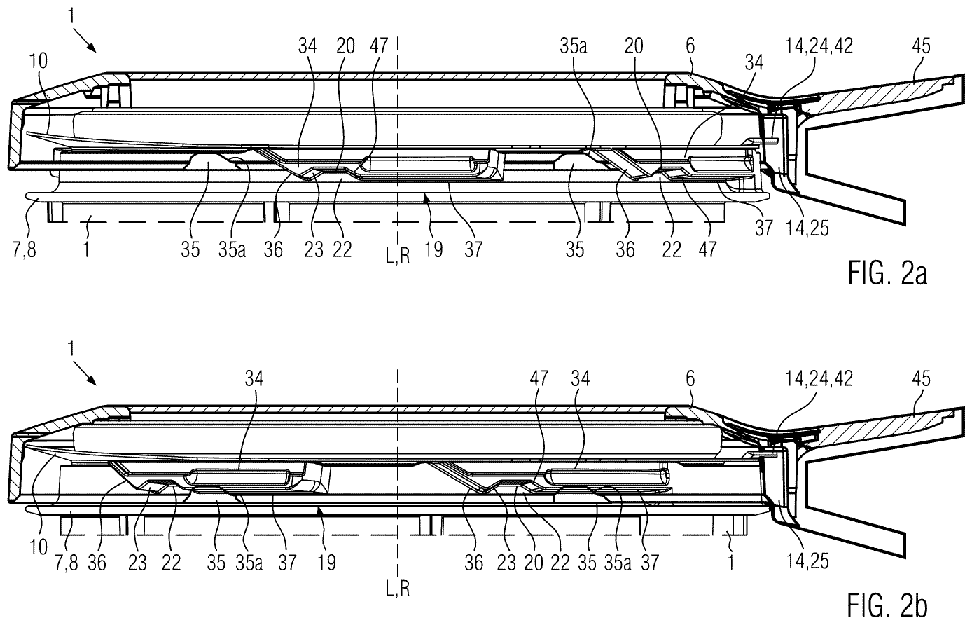

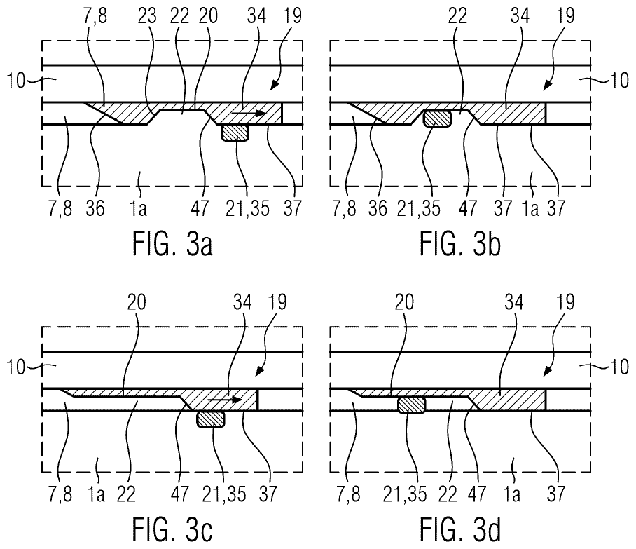

The structure of the preparation vessel 1a can be seen in particular in FIGS. 4 to 12c and FIG. 20. The preparation vessel 1a has at least one preparation chamber 5—see for example FIG. 4—for receiving food. The preparation chamber 5 can be closed with the lid 6, wherein the lid 6 can be locked with the preparation vessel 1a using a lid locking unit 7, as will be described below in particular with reference to FIGS. 2a to 2c. The lid 6 has a handle piece 45. The handle piece 45 has a first handle piece element 45a and a second handle piece element 45b that are arranged approximately V-shaped to each other.

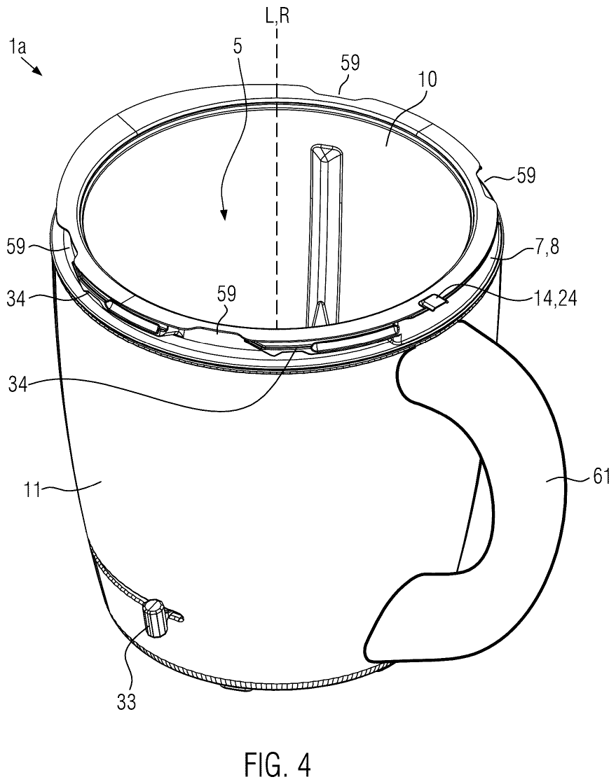

The preparation vessel 1a has an inner pot 10 according to FIGS. 4, 5 and 9, in which the preparation chamber 5 is formed. The inner pot 10 of the preparation vessel 1a can be inserted into a housing 11 and detachably lockable in the housing 11. The housing 11 is shown separately in FIGS. 5, 6, 7 and 20. FIG. 4 shows the completely assembled preparation vessel 1a with locked inner pot 10. FIG. 5 shows an exploded view, namely a view of the inner pot 10 during insertion respectively removal into or from the housing 11, for example for cleaning purposes. An electrical interface 9 of the preparation vessel 1a is firmly connected to the inner pot 10. Furthermore, a cable routing and electronics channel 60, which contains a subsequently described detection means 55, is arranged on the inner pot 10. A tool 26a, here a tool for cutting and stirring, is firmly connected to the removable tool holder 26. Alternatively, it is provided that the tool 26a is detachable from the tool holder 26. The tool holder 26 can then be inserted into the inner pot 10, preferably also locked, with and without tool 26a.

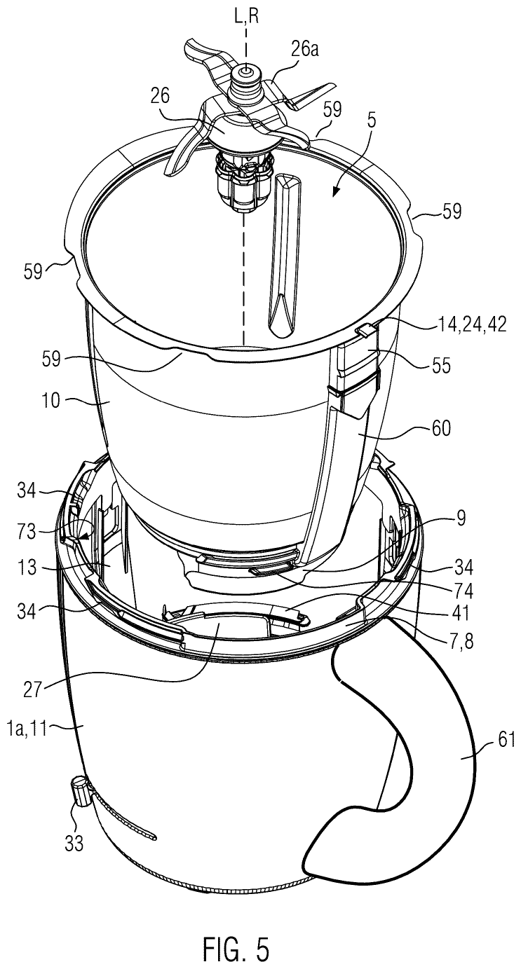

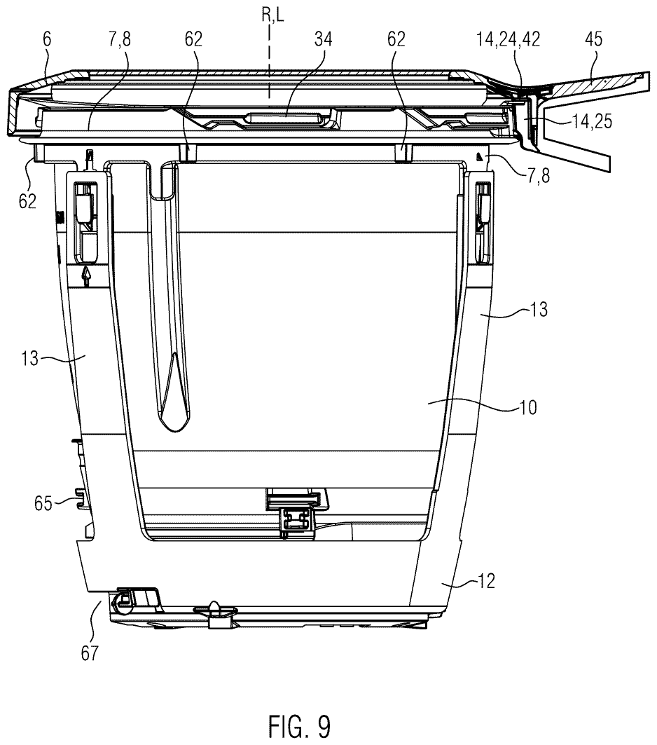

In the housing 11 of the preparation vessel 1a, a locking unit 27 as well as a counter-element 12, a transmission element 13 and a lid locking element 8 of a lid locking unit 7 are advantageously held rotatably about a rotation axis R respectively a longitudinal axis L of the preparation vessel 1a. In the assembled state—for example according to FIG. 4—in particular the transmission element 13 is arranged and rotatable in an intermediate space between the inner pot 10 and the housing 11. The counter-element 12, the transmission element 13 and the lid locking element 8 are designed such that they surround the inner pot 10 (see in particular FIG. 9, in which the housing 11 is omitted). FIG. 6 shows a perspective view into the housing 11 without inner pot 10. FIG. 6 shows the preparation vessel 1a in partially assembled representation. The inner pot 10 is removed. The locking unit 27 is rotatable on webs 41 on the inside of the housing 11 between stop positions.

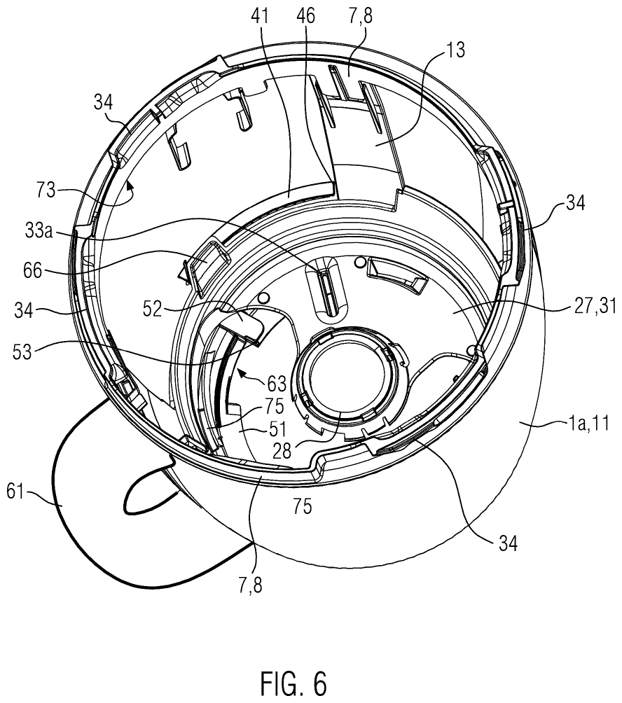

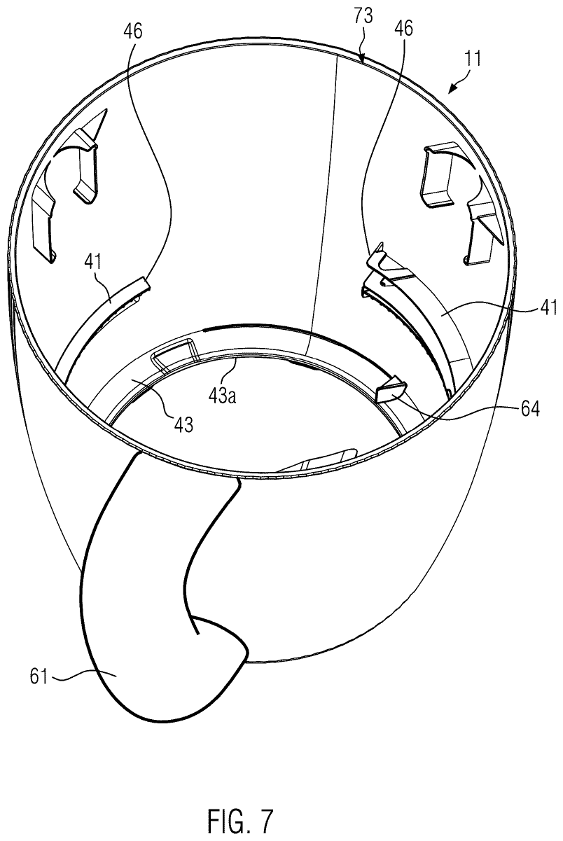

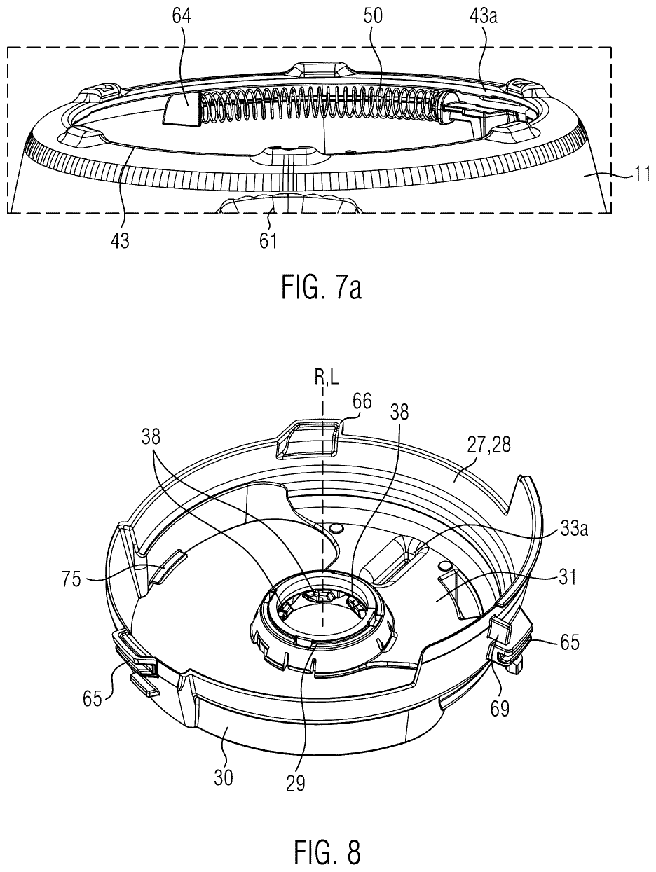

The cooperation between the webs 41 and, for example, a guide piece 66 of the locking unit 27 advantageously occurs according to the tongue-and-groove principle. The locking unit 27 also has grooves 65 in which the webs 41 can be guided (see also FIG. 8). In the state shown in FIG. 6, the carrier 28 of the locking unit 27 rests against the transmission element 13, so that the locking unit 27 respectively the carrier 28 according to FIG. 6 cannot be rotated counterclockwise. Furthermore, the transmission element 13 also cannot be rotated as long as the locking unit has not yet been moved. The transmission element 13 is supported in a counterclockwise rotation direction against an end stop 46 on one of the webs 41. Movement of the transmission element 13 from the position shown in FIG. 6—lid release position—in the clockwise rotation direction is limited by another end stop 46 on a web 41 (see FIG. 7). Consequently, two end stops 46 for the transmission element 13 are formed on the inside of the housing 11.

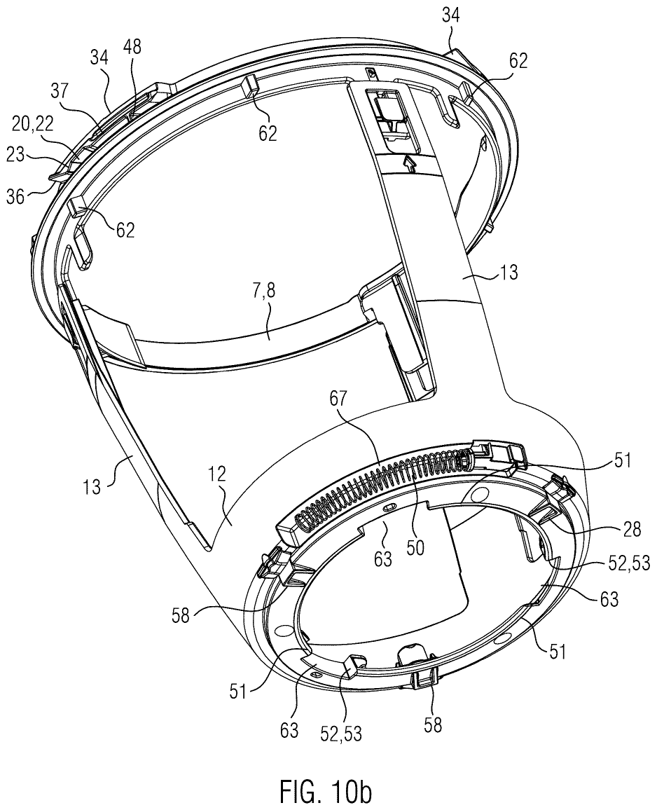

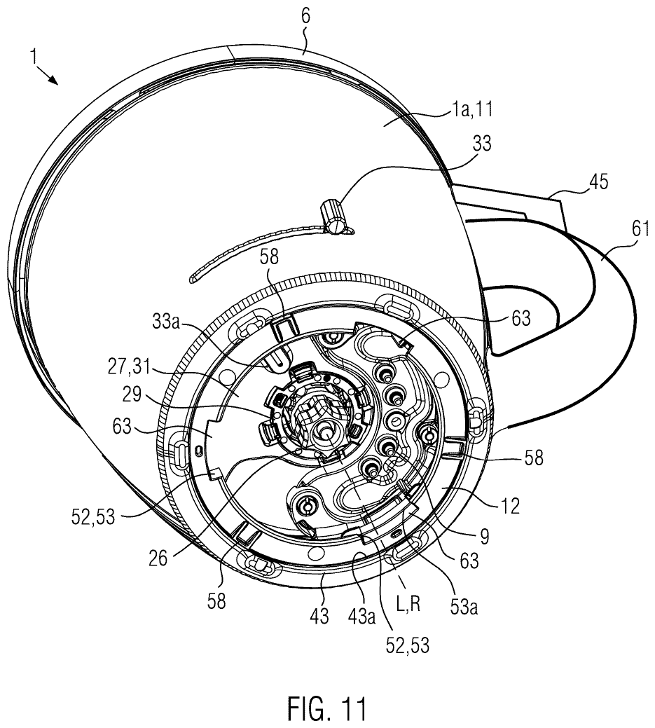

FIG. 7 shows a perspective view into the housing 11 without any attachments, consequently in particular only the shell. The housing 11 in this embodiment is formed from a thermally insulating material, here plastic. The distance between inner pot 10 and housing 11 provides additional thermal insulation. In the inserted state, the inner pot 10 is completely circumferentially and with respect to its height surrounded by the housing 11 (see FIG. 4). On its inside, the housing 11 according to FIGS. 5, 6, 7 and 20 has the described webs 41 that serve for mounting the locking unit 27. In particular, axial forces in a direction parallel to the rotation axis R can be transmitted from the locking unit 27 to the housing 11 via the webs 41. The housing 11 has an inward-projecting edge 43 in its lower area, on whose inner end face 43a the assembled counter-element 12 is supported with bearing points 58 in the radial direction (see in particular FIGS. 11 and 12a to 12c).

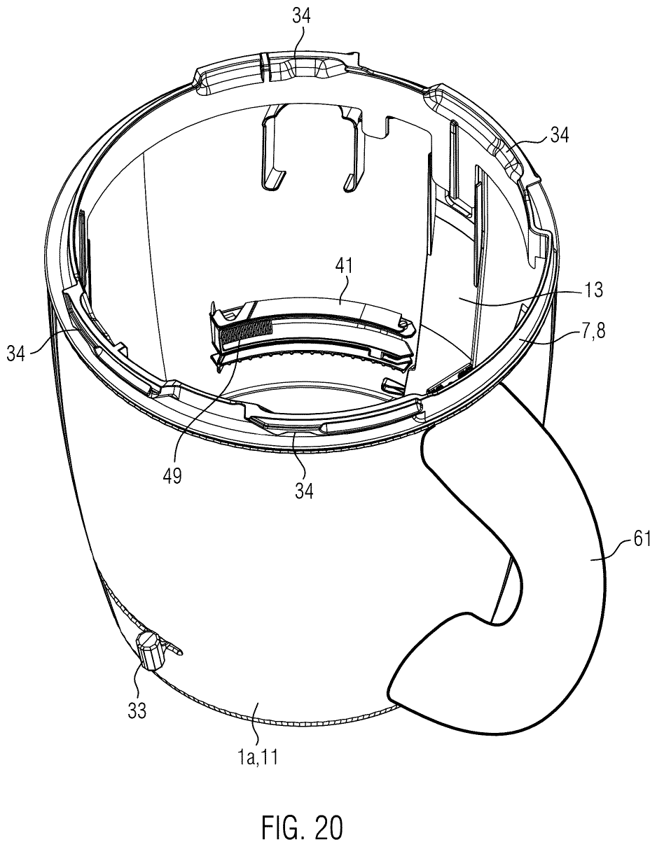

Below the web 41 shown on the right in FIG. 7, a channel is formed in which, according to FIG. 20, a first return means 49, here in the form of a spring, can be arranged. The first return means 49 cooperates in the assembled state with a projection 69 on the locking unit 27 (see for example FIG. 8) to always urge the locking unit 27 into a release position according to FIG. 12c so that a tool holder 26 can be inserted. Furthermore, a support element 64 for a second return means 50, here also in the form of a spring, is formed on a lower edge 43 (see in particular FIGS. 7 and 7a). In FIG. 7a, the second return means 50 is shown only for understanding purposes. The return means 50 is held in the assembled state in a receptacle 67 on the locking element 27 (see FIGS. 8, 9, 10a and 10b).

To assemble the inner pot 10 in the housing 11, first the inner pot 10 is introduced into the housing 11—see FIG. 5. Subsequently, a tool holder 26 with mounted tool 26a, here a cutting and stirring tool, is inserted through the inner pot 10 and through a locking ring 29 of a carrier 28 of the locking unit 27. The locking ring 29 has, for example, an inner diameter between 29.5 mm and 35.5 mm, in particular of about 32.5 mm. The locking ring 29 is connected to an outer ring 30 of the carrier 28 by a retaining web 31. Furthermore, the carrier 28 has a counter-rib 75 on an inside (see in particular FIG. 8) that—as will be described below—is designed for cooperation with a rib 74 on the inner pot 10 (see FIG. 5). FIG. 12c shows by way of example a view of the preparation vessel 1a from below with inserted inner pot 10, but still without tool holder 26. An electrical interface 9 of the inner pot 10 is accessible from the underside of the preparation vessel 1a so that it can cooperate with an electrical counter-interface 32 when the preparation vessel 1a is arranged in a receiving area 2 of a kitchen appliance base 3 (see FIGS. 1, 16 and 17).

The inner pot 10 has, in particular according to FIG. 5, in particular at a foot area, at least one rib 74. The rib 74 is oriented orthogonally to a rotation axis of the tool 26a for the inner pot 10. Preferably, the housing 11, in particular the locking unit 27, has at least one counter-rib 75 (see FIGS. 6 and 8). The counter-rib 75 is arranged in the locking position of the locking unit 27 such that it collides with the rib 74 on the inner pot 10 when an attempt is made to insert the inner pot 10 into the housing 11. This prevents the inner pot 10 from being insertable into the housing 11 when the housing 11—without inner pot 10—is arranged on a kitchen appliance base 3, in particular it is thus prevented that the inner pot 10 can be subsequently inserted. When the housing 11—alone—is arranged on the kitchen appliance base 3, cooperation with the actuating unit 2a prevents unlocking of the locking unit 27 from occurring. In the unlocking position of the locking unit 27, the inner pot 10 is insertable into the housing 11.

In FIG. 12c, the locking unit 27 is in a first position—release position—in which the tool holder 26 can pass through the locking ring 29. The locking unit 27 has an actuating handle 33 with which it can be rotated from the first position according to FIGS. 12c and 12b—release position—to a second position according to FIG. 12a—locking position. Alternatively or additionally to the first actuating handle 33, the locking unit 27 has an alternative actuating handle 33a that is accessible from the underside of the preparation vessel 1a.

According to FIG. 12b, the tool holder 26 is inserted but not yet locked with the locking unit 27. Locking occurs by a user moving the actuating handle 33-or the alternative actuating handle 33a—to the second position according to FIG. 12a. The locking ring 29, which can be passed through by the tool holder 26, has according to FIGS. 8 and 12a to 12c a plurality of hooks 38 on its inner circumference that are designed for form-fitting cooperation with the locking ring 29. When the locking unit 27 and thus also the hooks 38 on the locking ring 29 are rotated, form-fitting locking of the tool holder 26 with the locking unit 27 occurs through the hooks 38. Because the tool holder 26 also passes through the inner pot 10, the inner pot 10 is also locked with the housing 11 through the locking of the tool holder 26. For cleaning purposes, the tool holder 26 with the tool 26a and the inner pot 10 can be removed in reverse order, in particular by unlocking by moving the actuating handle 33 from the second position according to FIG. 12a to the first position according to FIG. 12b.

The locking unit 27 has a first return means 49 (see FIG. 20) in the form of a return spring. The first return means 49 acts between the housing 11 and the locking unit 27 to urge the locking unit 27 at least when no tool holder 26 is inserted in the direction of a release position for the tool holder 26 according to FIG. 12c. As a result, the actuating handle 33 is also always in the position according to FIG. 12c. In addition, a second return means 50, in particular also in the form of a return spring, is provided that acts between the locking unit 27 and the counter-element 12. The second return means 50 urges the counter-element 12 in the direction of a second position, which here corresponds to the locking position, so that the preparation vessel 1a cannot be arranged in the receiving area 2 of a kitchen appliance base 3 when no tool holder 26 is present or an existing tool holder 26 is not locked—as shown in FIG. 12a. In the state shown in FIG. 12b, placement in the receiving area 2 is not possible.

The lid locking element 8, the transmission element 13 and the counter-element 12 are rotationally fixed to each other according to FIGS. 6, 9, 10a and 10b so that they can be rotatably mounted about a rotation axis R within the housing 11 of the preparation vessel 1a (see in particular FIGS. 6 and 9). The lid locking element 8 is supported on an inner surface of the housing 11 respectively the shell at an upper edge 73 with a plurality of radial bearing points 62 (see FIGS. 6, 7 and 10b). The unit of lid locking element 8, transmission element 13 and counter-element 12 is mounted in the housing 11 in particular via the bearing points 62 of the lid locking element 8 and the bearing points 58 of the counter-element 12.

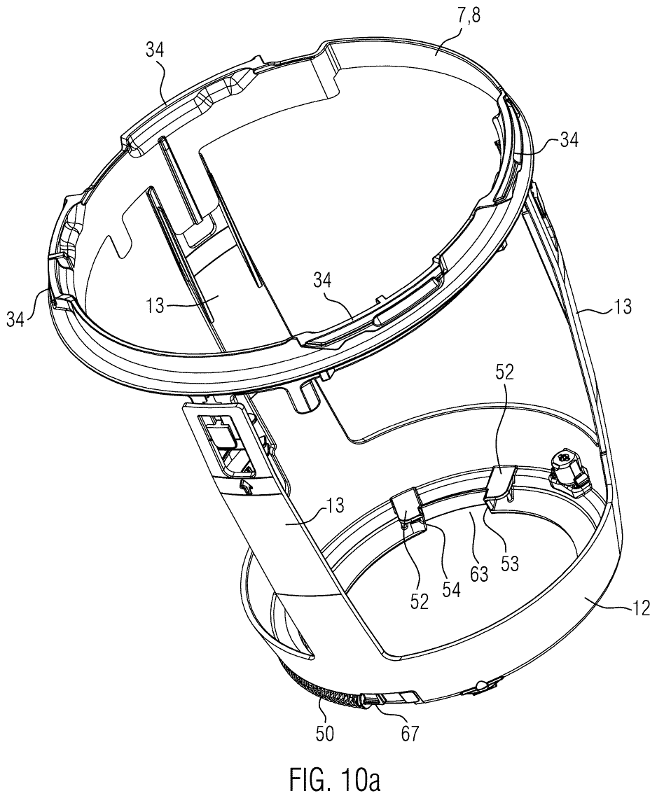

In this embodiment—as shown in particular in FIGS. 9 and 10a, 10b—the counter-element 12 and the transmission element 13 are formed in one piece, wherein the unit of counter-element 12 and transmission element 13 is form-fittingly connected to the lid locking element 8. The transmission element 13 has three substantially vertically extending arms, at the ends of which connection to the lid locking element 8 occurs in each case.

In the assembled state, in particular according to FIGS. 5, 6 and 9, the counter-element 12 is rotatable between a first position and a second position. Because the lid locking element 8 and the counter-element 12 are rotationally fixed to each other via the transmission element 13, the lid locking element 8 is in the lid release position when the counter-element 12 is in the first position, and the lid locking element 8 is in the lid locking position when the counter-element 12 is in the second position. Through this cooperation, rotation of the counter-element 12, in particular caused by the kitchen appliance base 3, can cause automatic locking and unlocking of the lid 6 as described below with reference to FIGS. 2a to 2c. The counter-element 12 is designed for cooperation with the kitchen appliance base 3, in particular with the actuating unit 2a in the receiving area 2.

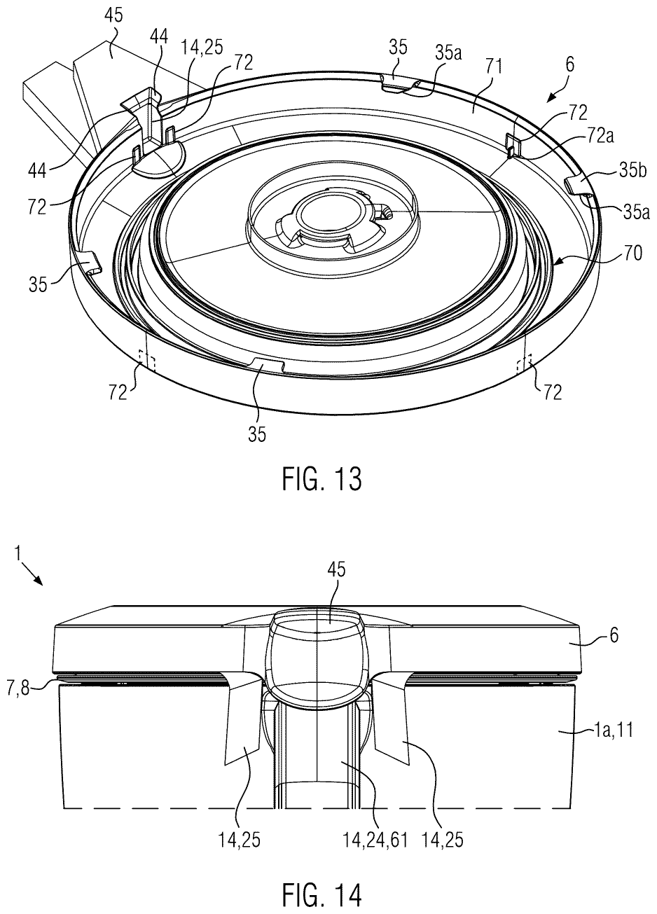

The preparation module 1, here the preparation vessel 1a with the lid 6, can be introduced into the receiving area 2 of a kitchen appliance base 3, as shown in FIG. 1. In particular, the preparation vessel 1a can be arranged with its foot area—with and without lid 6—in the receiving area 2. FIGS. 16, 17 and 21 show a detail view of a top surface 3a of a kitchen appliance base 3 with receiving area 2. The receiving area 2 has an actuating unit 2a with a drive unit 15, an actuating element 16 rotatably held about a rotation axis R1, and three stationary holding elements 17. The holding elements 17 are arranged at an angle of about 120° to each other and each have a convexly curved holding surface 17a that is oriented toward the top surface 3a.

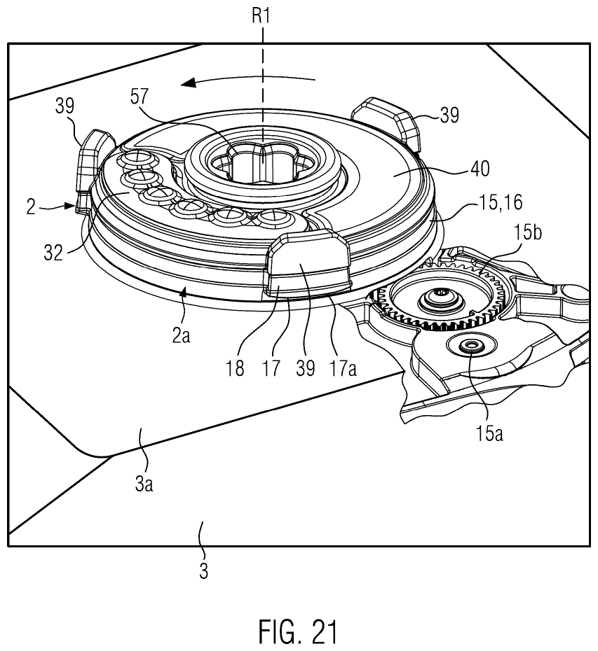

To be able to move the actuating element 16, the drive unit 15 has, in particular according to FIG. 21, at least one motor 15a and at least one gear wheel 15b. FIG. 21 shows an embodiment of a kitchen appliance base 3 with partial cutout. The gear wheel 15b is in form-fitting engagement with the actuating element 16 to rotate the actuating element 16. For example, the actuating element 16 has a toothing into which the gear wheel 15b engages-not shown. The motor 15a, of which only the shaft end is shown, is directly connected to the gear wheel 15b.

Above the holding elements 17, the actuating element 16 is rotatably arranged. The actuating element 16 has three driver elements 18 that in the first position shown in FIG. 16 completely overlap in a direction parallel to the rotation axis R1 of the actuating element 16. Above the driver elements 18, an insertion element 39 is arranged in each case, which like the holding element 17 is stationary. According to FIG. 16, the insertion element 39 in the first position is also in complete overlap with the driver element 18 respectively the holding element 17 in a direction parallel to the rotation axis R1. The electrical contacts of the counter-interface 32, which are designed for cooperation with the electrical interface 9 of the preparation vessel, e.g., according to FIG. 11, are covered with a contact cover 40. The actuating unit 2a surrounds a centrally arranged tool interface 57 that is designed for form-fitting cooperation with the tool holder 26 (see FIG. 11) and is joined with it when the preparation vessel 1a is arranged in the receiving area 2.

The holding elements 17 and/or the driver elements 18 and/or the insertion elements 39 have, for example, a width—in the circumferential direction—between about 23 mm and 27 mm. In particular, the width is about 25 mm. The driver elements 18 preferably have—in a direction parallel to the rotation axis R—a height between 3.5 mm and 5.5 mm. In particular, the height is about 4.5 mm. The actuating unit 2a has, starting from the top surface 3a of the kitchen appliance base 3, in particular about a height—up to the top of the contact cover 40—about 16 mm to 20 mm. In particular, the height is about 18 mm. The insertion elements 39 preferably have, starting from the top surface 3a of the kitchen appliance base 3, about a height between 21 mm and 25 mm. In particular, the height is about 23 mm. The actuating unit 2a has—starting from the rotation axis R1—in particular a radius of 45 mm to 55 mm. In particular, the radius is about 50 mm. The same applies to the actuating element 16 and the contact cover 40. The insertion elements 39 and/or the driver elements and/or the holding elements 17 preferably have—starting from the rotation axis R1—a radius of about 49 mm to 61 mm. In particular, the radius is about 53.5 mm.

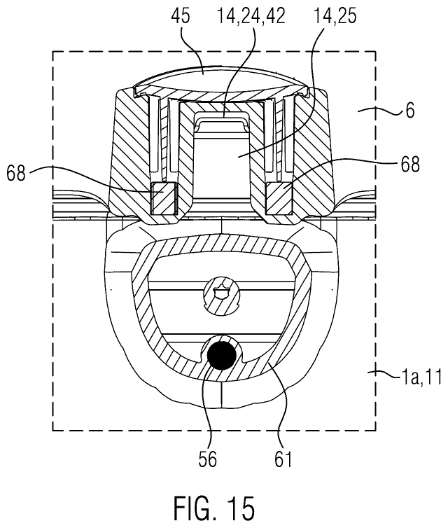

To effect a mechanical function on the preparation vessel 1a, the actuating element 16 with the driver elements 18 is rotatable by the drive unit 15 at least to a second position according to FIG. 17. In the second position, the driver elements 18 are swiveled out of the overlap in a direction parallel to the rotation axis R1 with the holding elements 17 and the insertion elements 39.

The actuating unit 2a protrudes from the top surface 3a of the kitchen appliance base 3 so that it can at least partially enter an underside of the preparation vessel 1a when the preparation vessel 1a is inserted into the receiving area 2.

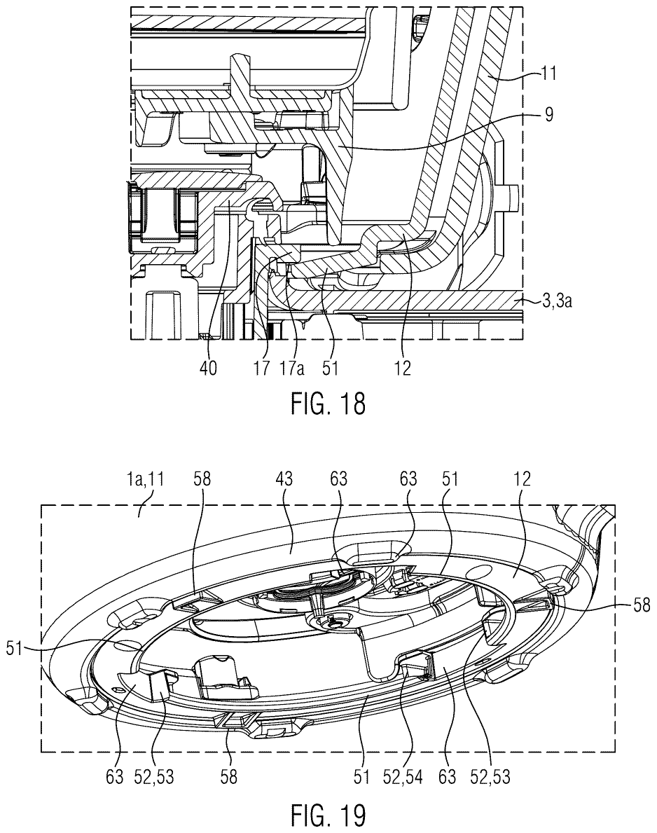

In the applied state of the preparation vessel 1a in the receiving area 2 of a kitchen appliance base 3, for example according to FIGS. 11, 16, 17, 18 and 19, an insertion element 39, a driver element 18 and a holding element 17 each pass through the counter-element 12 through one of the recesses 63. The recesses 63 are dimensioned such that entry can only occur when the insertion element 39, the driver element 18 and the holding element 17 completely overlap in a direction parallel to the rotation axis R1. The recesses have in particular a width—in the circumferential direction—of about 24 mm to 28 mm, in particular of about 26 mm. Furthermore, the actuating unit 2a enters the counter-element 12 from below through a central opening (see FIGS. 10b and 19). The central opening has a radius of about 47 mm to 57 mm, in particular of about 52 mm.

The electrical counter-interface 32 of the kitchen appliance base 3 is contacted with the electrical interface 9 of the preparation vessel 1a when introduced into the receiving area 2, for example according to FIG. 11. Furthermore, the tool interface 57 of the receiving area 2 is also connected to the corresponding interface of the tool holder 26 (see in particular FIG. 11).

The display and input device 3b is arranged on a device front of the kitchen appliance base 3, opposite is a device rear (see FIG. 1). When the preparation vessel 1a is arranged in the receiving area 2, the handle 61 of the preparation vessel 1a is oriented toward the display and input device 3b. The actuating unit 2a is further oriented such that an insertion element 39 of the actuating unit 2a is aligned approximately on an imaginary line with the handle 61. The insertion element 39 is oriented toward the device rear. The actuating unit 2a is essentially circular. Starting from the insertion element 39, which is aligned on a line with the handle respectively a central axis of the display and input device 3b, the two other insertion elements 39 are evenly distributed on the circumference. On the circumference opposite to the previously described insertion element 39, the electrical counter-interface 32 is arranged (see FIGS. 16 and 17). The electrical counter-interface 32 is oriented on the circumference toward the handle 61 respectively the device front. This arrangement supports positioning of the preparation module 1 when it is placed, for example, tilted slightly forward or backward. Either the rear insertion element 39 (the one arranged on the imaginary line, on the side facing the rear of the kitchen appliance base 3) or the two front insertion elements 39 (those arranged laterally from the electrical counter-interface 32) guide, which support the rough front alignment with regard to the contacts of the counter-interface 32.

The rotation of the driver elements 18 between a first position according to FIG. 16 and the second position according to FIG. 17 relative to the holding elements 17 and the insertion elements 39 is advantageously used to cause rotation of the counter-element 12, e.g., to effect a mechanical function within the preparation vessel 1a, in particular to lock the preparation vessel 1a with the kitchen appliance base 3. The rotation preferably occurs at an angle of about 30°, wherein preferably first an angle of about 32° is approached and then a return of about 2° occurs to reduce stresses in the moved components.

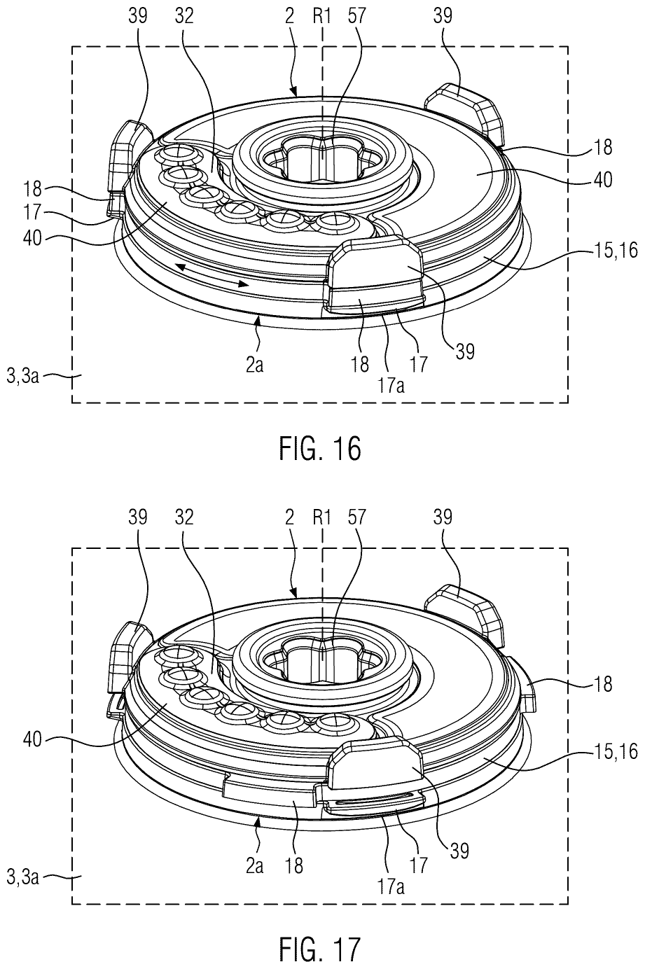

During rotation of the actuating element 16, the driver elements 18 are rotated, which each cooperate with a driver counter-surface 53 of the driver counter-element 52 of the counter-element 12 (see FIGS. 10a, 10b and 19) and thereby also cause rotation of the counter-element 12 in the intermediate space between inner pot 10 and housing 11. The counter-element 12 has a plurality of active sections 51 protruding in the direction of the rotation axis R1, which each have a driver counter-element 52 with a driver counter-surface 53. When the preparation vessel 1a is introduced into the receiving area 2, the rotation axes R, R1 and the longitudinal axis L are preferably coaxial. The driver counter-surface 53 is arranged offset along a direction parallel to the rotation axis R1 to the active section 51, namely located above the active section 51. Through rotation of the counter-element 12, the active sections 51 of the counter-element 12 are rotated under the concavely curved holding elements 17, whereby the preparation vessel 1a is locked with the kitchen appliance base 3. The locked state is shown in section in FIG. 18.

Since the counter-element 12 is rotationally fixed about the rotation axis R to the transmission element 13 and the lid locking element 8, when the counter-element 12 moves, the lid 6 is simultaneously locked or unlocked with the preparation vessel 1a by the locking cam tracks 34—as described below with reference to FIGS. 2a to 2c—cooperating with cams 35 on the lid underside of the lid 6.

In the illustrated embodiment, advantageous locking of the preparation vessel 1a with the kitchen appliance base 3 thus occurs simultaneously with locking of the lid 6 with the preparation vessel 1a. Unlocking of the preparation vessel 1a from the kitchen appliance base 3 occurs in reverse order, namely by the driver elements 18 cooperating in the opposite direction with the driver counter-element 52 of the counter-element 12, in particular with a return surface 54, and rotating the counter-element 12 so far in the opposite direction until the active sections 51 of the counter-element 12 no longer overlap with the holding elements 17 in a direction parallel to the rotation axis R, so that the holding elements 17, the driver elements 18 and the insertion elements 39 can exit outward through the recesses 63 again when the preparation vessel 1a is lifted from the receiving area 2 (see in particular FIG. 18).

At the same time, by rotating the counter-element 12 in the opposite direction via the transmission element 13, the lid locking element 8 is also rotated in the opposite direction, namely toward the lid release position, so that the lid 6 is removable in the lid release position.

However, if pressure is present in the preparation chamber 5 during rotation toward the lid release position or the user pulls on the lid 6, a blocking means 19 reaches the blocking position—as described below for FIGS. 2a to 2c—and thus prevents further rotation of the lid locking element 8, but also of the counter-element 12. This blocking is detected by the drive unit 15 respectively by the control unit based on an increased current strength and the rotation is stopped.

It is preferably provided that first a rotation in the opposite direction occurs, namely the active sections 51 are rotated back under the holding elements 17 and the locking cam tracks 34 are rotated back to the lid locking position. Only after a predetermined time has elapsed or by renewed initiation by a user is another process of unlocking or lid release started.

FIGS. 2a to 2c show an upper part of a preparation module 1, namely a lid 6 applied to a preparation vessel 1a in different locking states. The lid 6 has, for example, a total height—in a direction parallel to the longitudinal axis L—between about 24 mm and 28 mm. In particular, the total height is about 26 mm. At an upper edge of the preparation vessel 1a, the lid locking unit 7 is arranged, which can interact with the lid 6. FIG. 2a shows the lid locking unit 7 in the lid release position, FIG. 2b shows the lid locking unit 7 in the lid locking position, and FIG. 2c shows the lid locking unit 7 in a position between the lid locking position and the lid release position in which a blocking means 19 of the lid locking unit 7 is in a blocking position. Because the blocking means 19 is in the blocking position, movement of the lid locking unit 7 toward the lid release position according to FIG. 2a is prevented.

The blocking means 19 is in the blocking position according to FIG. 2c because a force parallel to a longitudinal axis L of the preparation vessel 1a away from the preparation vessel 1a acts on the lid 6. This force is caused either by a force from the preparation chamber 5 acting on the lid 6, for example emanating from a rotating vortex of food or pressure prevailing in the preparation chamber 5, or by a user attempting to lift the lid 6 from the preparation vessel 1a.

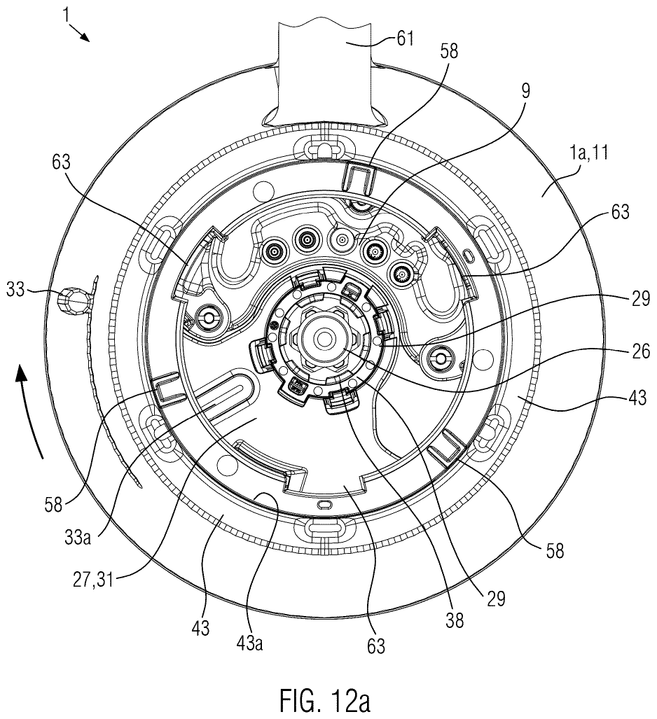

According to FIG. 2c, the lid locking unit 7 is at least partially moved toward the lid release position when the blocking means 19 is in the illustrated blocking position. The blocking means 19 reaches the blocking position through a translational movement of the lid 6, in particular in a direction parallel to the longitudinal axis L of the preparation vessel 1a (see FIG. 2c). The blocking means 19 has a plurality of first blocking surfaces 20, a plurality of second blocking surfaces 23, and a plurality of blocking elements 21. A translational movement of the lid 6 parallel to the longitudinal axis L is limited by the blocking elements 21 resting against the respective first blocking surface 20. The blocking elements 21 are here designed as radially inward-protruding cams 35 on the lid 6 (see also FIG. 13), which also serve for locking the lid 6.

The cams 35 have, for example, a width of about 10 mm to 14 mm, in particular of about 12 mm, and/or a depth—in the radial direction—between 5 mm and 7 mm, in particular of about 6 mm, and/or a height—in a direction parallel to the rotation axis R—between 3.5 mm and 5.5 mm, in particular of about 4.5 mm.

The first blocking surfaces 20 and the second blocking surfaces 23 are surfaces in a recess 22 in a locking cam track 34 that is formed on a lid locking element 8 of the lid locking unit 7. The first blocking surfaces 20 have, for example, a width between 5.5 mm and 7.5 mm, in particular of about 6.5 mm. The locking cam track 34 preferably has a height in a direction parallel to the rotation axis R of about 6.6 mm to 8.6 mm, in particular of about 7.6 mm. The lid locking element 8 is rotatably mounted about a rotation axis R, which coincides, for example, with the longitudinal axis L of the preparation vessel 1, at least between a lid release position and a lid locking position. The lid locking element 8 is essentially ring-shaped and is rotatable both relative to the lid 6 and relative to the preparation chamber 5 (see in particular FIGS. 2a and 2b). So that the cams 35 of the lid 6 according to FIGS. 2a to 2c can cooperate with the lid locking unit 7 respectively the lid locking element 8, the inner pot 10 according to FIGS. 4 and 5 has a number of recesses 59 in its upper edge 73 corresponding to the number of cams 35. The recesses 59 are preferably arranged in pairs, wherein an angle of about 60° is formed between the recesses 59 of a pair—starting from the longitudinal axis L. An angle of about 120° is formed between the recesses 59 of the two pairs in each case. In the embodiment of FIGS. 4 and 5 with an extension 42 on the inner pot 10, for example, an angle between the extension 42 and the first recess 59 adjacent to the extension 42 is about 60°. From each of the adjacent recesses 59 to the respective next recess 59, the angle is also about 60°.

The lid locking unit 7 has four locking cam tracks 34 on the lid locking element 8 that cooperate form-fittingly with the cams 35 to lock the lid 6 so that it closes the preparation chamber 5. The locking cam tracks 34 are rotatable together with the lid locking element 8 about the longitudinal axis L respectively the rotation axis R relative to the lid 6 as well as to the preparation chamber 5. For cooperation with the cams 35 formed on the lid 6, the locking cam tracks 34 each have a run-up slope 36 that causes an axial displacement of the cams 35 in a direction parallel to the longitudinal axis L of the preparation vessel 1a during rotation of the lid locking element 8 toward the lid locking position by the lid 6 being pulled toward the preparation chamber 5 at the cams 35. The run-up slope 36 has, for example, a length between 13 mm and 17 mm, in particular of about 15 mm. During further rotation of the lid locking element 8, the cams 35 each enter the recess 22 of the blocking means 19 and then slide out of the recess 22 along a guide slope 47 until they finally each rest against a locking surface 37 oriented substantially orthogonally to the longitudinal axis L to lock the lid 6. Preferably, the locking surface 37 and the first blocking surface 20 are arranged offset from each other by about 2.5 mm to 4.5 mm, in particular about 3.5 mm, along the rotation axis R.

If the lid locking unit 7 is in the lid locking position according to FIG. 2b and a user attempts to unlock the lid 6 by rotating the lid locking element 8 toward the lid release position, but a force emanating from the preparation chamber 5 still acts on the lid 6, the cams 35 are pressed into the recess 22 together with the lid 6 as part of a translational movement during movement toward the lid release position. Through the form-fitting cooperation of the cams 35 with at least part of the respective second blocking surface 23, further movement of the lid locking element 8 toward the lid release position is then mechanically blocked. The blocking means 19 is in the blocking position.

Through this function, the present disclosure ensures that the lid can only be opened by a user when no food can escape. In addition, it is ensured that blocking of the opening of the lid 6 only occurs when a force really acts on the lid 6. This avoids unnecessary waiting times for a user.

The rotatably mounted lid locking element 8 is supported at least in the lid locking position according to FIG. 2c on an underside of an upper edge of the inner pot 10 to achieve force transmission in a direction parallel to the longitudinal axis L of the preparation vessel 1a respectively the rotation axis R.

Exactly one stop element 48—see FIG. 10b—is formed on the lid locking element 8, which rests against exactly one cam 35, 35b in the lid locking position to prevent further rotation of the lid locking element 8 and thereby define the lid locking position. The resting can be detected, for example, by a control unit of the kitchen appliance base 3. The cam 35, 35b is arranged at approximately 240° in a polar coordinate system aligned with the lid 6—the lid underside—in which the longitudinal axis L respectively the rotation axis R forms the pole and the handle piece 45 is arranged at 0°. The cam 35, 35b whose resting is detectable is thus one of the cams 35 that is arranged furthest away from the support unit 14 compared to the other cams. This increases the reliability of detecting the resting. By using only one stop element 48, the lid locking position is uniquely defined. It is preferably provided that a drive unit 15 of the kitchen appliance base 3, with which the lid locking element 8 is preferably rotatable, detects an increased current strength at a motor and then switches off the motor. The stop element 48 is designed as part of the locking cam track 34 and extends perpendicular to the locking surface 37.

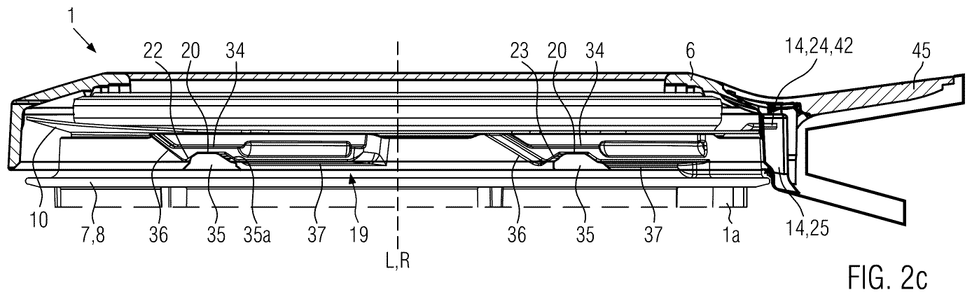

FIGS. 3a and 3b show an embodiment of a schematic structure of a blocking means 19 in partially sectioned detail view, which illustrates the functional principle of the blocking means 19 that is also used in FIGS. 2a to 2c. Starting from the lid blocking position in FIG. 3a, in which the cam 35 arranged on the lid 6 (see for example FIG. 13) rests against the blocking surface 37, rotation of the lid locking element 8 according to FIG. 3a occurs in the arrow direction to the right when the lid locking element 8 is to be moved to the lid release position. The cam 35 simultaneously forms a blocking element 21 of the blocking means 19.

If during movement of the lid locking element 8 toward the lid release position a force resulting from the preparation chamber 5 acts on the lid 6 or a user pulls on the lid 6, the blocking element 21 respectively the cam 35 moves through a translational movement of the lid 6 into the recess 22 of the blocking means 19 on the locking cam track 34 until the cam 35 rests against the first blocking surface 20 and the second blocking surface 23. The first blocking surface 20 limits the translational movement of the lid 6 away from the preparation vessel 1a and the second, obliquely arranged blocking surface 23 mechanically prevents further rotation of the lid locking element 8 toward the lid release position (see blocking position according to FIG. 3b). For example, this mechanical blockade is detected by a control unit of the kitchen appliance base 3, which causes rotation of the lid locking element 8 back to the lid locking position according to FIG. 3a.

FIGS. 3c and 3d show an alternative embodiment of a schematic structure of a blocking means 19 in partially sectioned detail view. According to FIG. 3c, the lid 6 is in the lid locking position in which the cam 35 of the lid rests against the locking surface 37. The cam 35 also forms the blocking element 21 of the blocking means 19 here. If the lid locking element 8 is now rotated to the right toward the lid release position according to FIG. 3c and a force emanating from the preparation chamber 5 acts on the lid 6 or a user pulls on the lid 6, a translational movement of the lid 6 and thus of the cam 35 into the recess 22 occurs until the cam 35 rests against the first blocking surface 20. The translational movement of the lid 6 is detected, for example, by a sensor—not shown—and further movement of the lid locking element 8 toward the release position is stopped. In this embodiment, the recess 22 has no second blocking surface 23; the blocking occurs by means of the control unit.

The lid locking element 8 is—as described—rotatable according to FIGS. 2a to 2c between a lid release position and a lid locking position to lock the lid 6 with the preparation vessel 1a. To prevent the lid 6 from rotating about the rotation axis R of the lid locking element 8 during movement of the lid locking element 8, the preparation module 1 according to FIGS. 2a to 2c, 4, 5, 13, 14 and 15 has a support unit 14 that is designed such that it allows axial movement of the lid 6 in a direction parallel to the rotation axis R respectively to the longitudinal axis L, but at the same time prevents rotation of the lid 6 when it is applied to the preparation vessel 1a. The support unit 14 has according to the embodiments of FIGS. 2a to 2c, 4, 5, 13 and 15 a support element 24 in the form of an extension 42 on the inner pot 10 and a support counter-element 25 in the form of a recess on the lid 6.

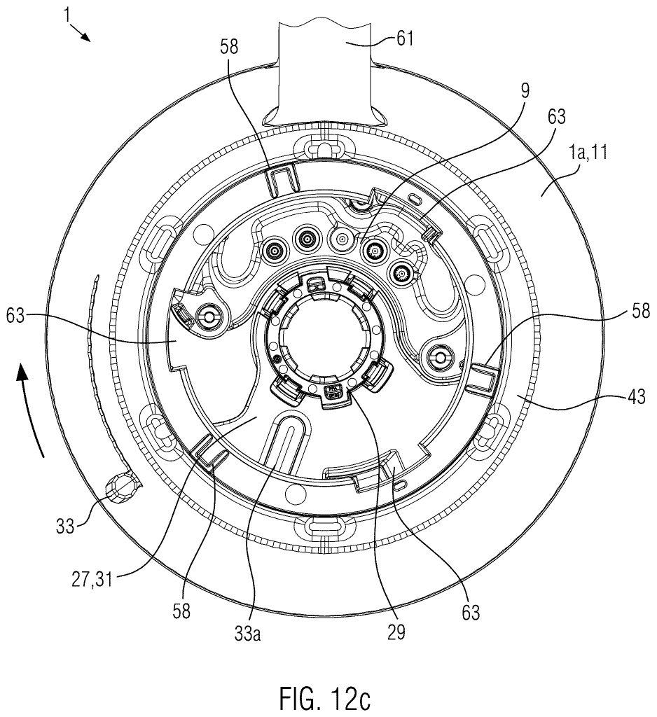

The support counter-element 25 and the support element 24 cooperate form-fittingly in the applied state of the lid 6 so that the lid 6 cannot rotate about the rotation axis R, but can be removed from the preparation vessel 1a in a direction substantially parallel to the rotation axis R (see in particular FIG. 15). The support element 24 in the form of the extension 42 can move in the height direction of the support counter-element 25 in the form of the recess, in particular during locking of the lid 6 with the preparation vessel 1a. The different positions of the support element 24 in the support counter-element 25 can be seen, for example, in FIGS. 2a to 2c. In the lid locking position according to FIG. 2b, the position is different than in the lid release position according to FIG. 2a.

Additionally, the support element 24 and the support counter-element 25 are designed such that the lid 6 can be tilted upward about an axis defined by the support element 24 by pressing on the handle piece 45. The support element 24 in this embodiment is designed as a substantially U-shaped extension 42 on the inner pot 10. The extension 42 is formed in one piece with the inner pot 10. In particular according to FIGS. 4 and 5, the extension 42 is formed on an upper edge 73 of the inner pot 10. To facilitate in particular the insertion of the support element 24 into the support counter-element 25, the support counter-element 25 according to FIG. 13 has two insertion slopes 44 formed opposite to each other, which facilitate the sliding in of the extension 42 according to FIGS. 4 and 5 when applying the lid 6 to the preparation vessel 1a (see also FIG. 15). According to FIGS. 13 and 15, the support counter-element 25 is arranged in the area of the handle piece 45 of the lid 6.

FIG. 13 shows a lid 6 for a preparation vessel 1 from an underside. In the area of the handle piece 45, the lid 6 has the support counter-element 25 in the form of an elongated recess that extends substantially parallel to the rotation axis R respectively to the longitudinal axis L of the preparation vessel 1a when the lid 6 is on the preparation vessel 1a. The support counter-element 25 serves to prevent rotation of the lid 6 during movement of the lid locking element 8 by the support counter-element 25 cooperating form-fittingly with the support element 24 in the form of the extension 42 on the inner pot 10 (see FIGS. 2a to 3c, 4, 5 and 9) when the lid 6 is applied to a preparation vessel 1a. The four cams 35 extend radially inward. Each cam 35 has an inclined cam surface 35a for cooperation with the run-up slope 36 of a locking cam track 34 (see FIGS. 2a to 2c).

In a polar coordinate system aligned with the lid 6—the lid underside—in which the longitudinal axis L respectively the rotation axis R forms the pole and the handle piece 45 is arranged at 0°, the cams 35 are arranged at about 60°, 120°, 240° and 300°. The angle between the handle piece 45 and the respective first cam 35 on the circumference in both directions is thus about 60°. The angle between two cams 35 adjacent on one side of the handle piece 45 is also about 60°.

To ensure centering of the lid 6 on the preparation vessel 1a, the lid 6 has a plurality of centering elements 72 on the lid underside. According to FIG. 13, exactly five centering elements 72 are formed on the lid 6. The centering elements 72 protrude in the area of the setback 70 from an inner edge 71 of the setback 70 in the direction of the longitudinal axis L. The centering elements 72 are arranged in particular facing away from a free edge of the inner edge 71. Each centering element 72 extends only over part of the height of the inner edge 71 in the setback 70.

A first centering element 72 is arranged on the circumference of the lid 6 opposite to the handle piece 45. A second and a third centering element 72 are arranged in a polar coordinate system on the lid underside, in which the longitudinal axis L forms the pole and the handle piece is arranged at 0°, at angles of about 90° and about 270° on the circumference. The second and third centering elements 72 are advantageously arranged opposite to each other. Furthermore, a fourth and a fifth centering element 72 are each arranged on one side of the support counter-element 25 of the support unit 14.

At least the second and third centering elements 72 each have a web 72a that protrudes from the centering element 72 in the radial direction. The web 72a advantageously serves for axial positioning of the lid 6 in the state applied to a preparation vessel 1a.

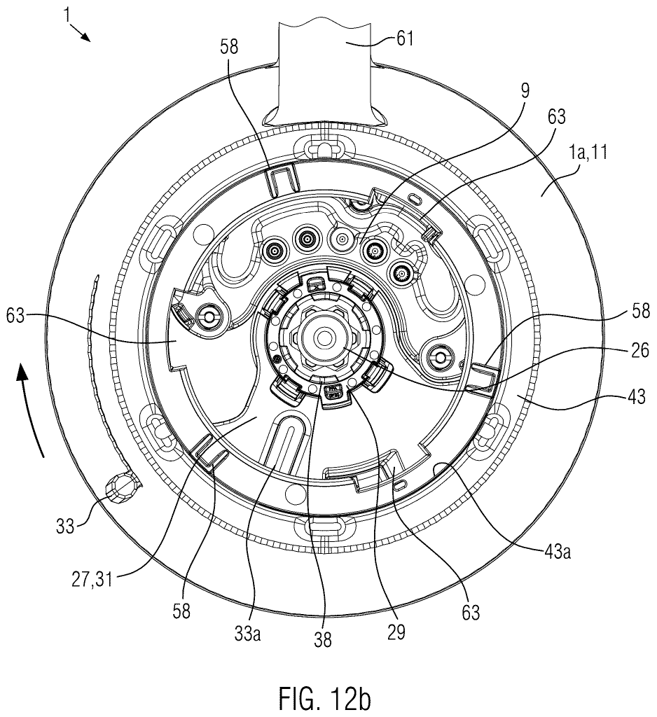

FIG. 14 shows an alternative embodiment of a support unit 14 that is formed on an outside of the lid 6 and the preparation vessel 1a. The support element 24 is formed by a handle 61 of the lid 6, wherein the support counter-element 25 is formed as webs on the lid 6 formed to the right and left of the handle 61. Furthermore, it is also conceivable that the support counter-element 25 is arranged in the form of two webs on the housing 11, and that the handle piece 45 serves as support element 24.

FIG. 15 shows a section through the handle 61 of the preparation vessel 1a and at least partially through the lid 6 in the area of the handle piece 45. In the illustrated section, the support counter-element 25 is shown in the form of a recess extending substantially parallel to the longitudinal axis L of the preparation vessel 1a, into which the support element 24 in the form of an extension 42 protruding from the inner pot 10 is introduced. The extension 42 is substantially U-shaped and connected in one piece to the inner pot 10. The extension 42 can move in the vertical direction according to FIG. 15 in the support counter-element 25. For insertion during application of the lid 6, the support counter-element 25 has the two insertion slopes 44 arranged opposite to each other. Furthermore, the lid can be tilted about an axis defined by the support element 24, for example by pressing on the handle piece 45, so that it opens at least on one lid side.

In the area of the attachment of the handle 61, a first identification means 56 is arranged, which is designed as a permanent magnet. A detection means 55 on the inner pot 10, which is arranged in particular in a cable routing and electronics channel 60, is designed to detect the presence and/or orientation of the magnet-its polarization. This allows the control unit of a kitchen appliance base 3 to detect whether the inner pot 10 is arranged in a housing 11 or not.

In the lid 6, in particular in the handle piece 45, a second identification means 68 in the form of two permanent magnets is also arranged. The detection means 55 is designed to detect the presence and/or orientation of the permanent magnets. Through different orientation-polarization-of the permanent magnets, for example, up to four different lids 6 can be detected.

Through different orientation of the two permanent magnets North-South, South-North, North-North and South-South, a total of four codings can be queried with which, for example, different embodiments of the lid 6 can be detected with the detection means 55. Depending on the embodiment of the lid 6, the second identification means 68 in the form of the permanent magnets is preferably coded differently. In addition, the presence of the second identification means 68 makes it detectable that a lid 6 is applied to the preparation vessel 1a at all.

The present disclosure is not limited to the illustrated and described embodiments, but also includes all embodiments having the same effect within the meaning of the invention. It is expressly emphasized that the embodiments are not limited to all features in combination, rather each individual partial feature can also have inventive significance detached from all other partial features. Furthermore, the present disclosure is also not yet limited to any specific feature combination defined herein, but can also be defined by any other combination of specific features of all individually disclosed features. This means that in principle practically every individual feature can be omitted or replaced by at least one individual feature disclosed elsewhere in the present disclosure. In other words, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A kitchen appliance base for a kitchen appliance, with at least one receiving area for at least one preparation module, wherein the receiving area has at least one actuating unit for mechanical interaction with the preparation module, wherein the actuating unit has at least one drive unit, at least one actuating element rotatably held about a rotation axis, and at least one stationary holding element, wherein the actuating element has at least one driver element, and wherein the actuating element is rotatable at least indirectly by means of the drive unit at least between a first position and a second position,
wherein the holding element and the driver element at least partially overlap in the first position in a direction parallel to the rotation axis of the actuating element.

2. The kitchen appliance base according to claim 1, wherein the driver element has no overlap with the holding element in the direction parallel to the rotation axis in the second position of the actuating element.

3. The kitchen appliance base according to claim 1, wherein the holding element extends substantially radially away from the rotation axis of the actuating element.

4. The kitchen appliance base according to claim 1, wherein the actuating unit has at least one insertion element in the receiving area, and that the insertion element and the holding element at least partially or completely overlap in a direction parallel to the rotation axis of the actuating element.

5. The kitchen appliance base according to claim 1, wherein at least one contact cover for at least partially covering an electrical counter-interface is arranged in the receiving area.

6. The kitchen appliance base according to claim 1, wherein a top side of the kitchen appliance base is substantially flat so that a preparation module can be placed on the top side in the receiving area, and that the tool interface protrudes in the receiving area.

7. The kitchen appliance base according to one of claim 1, wherein the actuating element is designed as an actuating ring, and that the driver element is designed as a radially protruding web.

8. The kitchen appliance base according to claim 1, wherein the drive unit has at least one motor and at least one gear wheel, and that the gear wheel is operatively connected to the actuating element to rotate the actuating element.

9. A preparation module for arrangement in a receiving area of a kitchen appliance base, having at least one counter-element rotatably mounted about a rotation axis, wherein the counter-element is rotatable at least between a first position and a second position,
wherein the counter-element has at least one active section protruding in the direction of the rotation axis and at least one driver counter-element, wherein the driver counter-element has at least one driver counter-surface for interaction with a driver element of the kitchen appliance base, and that the driver counter-surface is arranged offset along a direction parallel to the rotation axis from the active section.

10. The preparation module according to claim 9, wherein the preparation module has at least one preparation vessel and at least one lid, that the preparation vessel has at least one preparation chamber for receiving food and at least one lid locking element, that the counter-element has at least one transmission element rotatable with the counter-element about the rotation axis, and that the transmission element is operatively connected to the lid locking element so that the lid locking element is movable, in particular rotatable, at least between a lid release position and a lid locking position by rotation of the transmission element.

11. The preparation module according to claim 10, wherein a rotation of the counter-element and a movement of the lid locking element takes place relative to the preparation chamber and relative to the lid.

12. The preparation module according to claim 10, wherein the lid locking element has at least one locking cam track and the lid has at least one cam protruding toward the preparation interior space, and that the cam and the locking cam track effect locking of the lid on the preparation vessel when the lid locking element is in the lid locking position.

13. The preparation module according to claim 12, characterized in that wherein the locking cam track has at least one blocking position, and that the cam is forced into the blocking position as a blocking element of a blocking means during movement of the lid locking element toward the release position when force acts on the lid in a direction parallel to the rotation axis away from the preparation chamber, and that rotation of the lid locking element to the release position is blocked when the cam is in the blocking position.

14. A kitchen appliance with at least one kitchen appliance base according to claim 1 and at least one preparation module, arranged in the receiving area of the kitchen appliance base, the preparation module having at least one counter-element rotatably mounted about a rotation axis, wherein the counter-element is rotatable at least between a first position and a second position, the counter-element having at least one active section protruding in the direction of the rotation axis and at least one driver counter-element, wherein the driver counter-element has at least one driver counter-surface for interaction with the driver element of the kitchen appliance base, and that the driver counter-surface is arranged offset along a direction parallel to the rotation axis from the active section;
wherein the driver element, when the preparation module is arranged in the receiving area, interacts at least with a driver counter-surface of the counter-element to rotate the counter-element between a first position and a second position, wherein the active section engages under the holding element in the second position.

15. The kitchen appliance according to claim 14, wherein a rotation speed of the actuating element of the kitchen appliance base and of the counter-element of the preparation module are the same during rotation.

16. A method for operating a kitchen appliance base, with a preparation module at least comprising the following method steps:
Arranging the preparation module in a receiving area of the kitchen appliance base,
Effecting a rotation of an actuating unit of the kitchen appliance base with a drive unit, wherein the actuating unit interacts form-fittingly with a counter-element of the preparation module to rotate the counter-element at least relative to a housing, and wherein at least the housing is supported on at least one stationary insertion element to prevent rotation of the preparation module on the kitchen appliance base.

17. The method according to claim 16, wherein the counter-element has at least one active section that can be rotated under a stationary holding element of the kitchen appliance base by the rotation to lock the preparation module with the kitchen appliance base and can be rotated away from the holding element by an opposite rotation to unlock the preparation module from the kitchen appliance base.

18. (canceled)

19. The kitchen appliance base according to claim 3, wherein the holding element has at least one holding surface oriented toward a top side of the kitchen appliance base, and wherein at least part of the holding surface has a convex curvature.

20. The kitchen appliance base according to claim 4, wherein the driver element is at least partially or completely arranged between the insertion element and the holding element in the first position.

21. The kitchen appliance base according to claim 1, wherein the actuating unit with the contact cover protrudes from the top side in the receiving area so that at least one of the tool interface or the actuating unit with the contact cover can penetrate into the preparation module from the underside.

22. The kitchen appliance base according to claim 1, wherein the actuating element has at least or exactly three, at least or exactly four, or at least or exactly five driver elements.
